(19) United States
(12) Patent Application Publication
(10) Pub. No.: US 2019/0035049 A1
(43) Pub. Date: Jan. 31, 2019

(54) DITHERED VARIABLE RATE SHADING

(71) Applicant: QUALCOMM Incorporated, San Diego, CA (US)

(72) Inventors: Dam Backer, San Diego, CA (US); Brian Ellis, San Diego, CA (US); Bozhan Chen, Valencia, CA (US)

(21) Appl. No.: 15/954,384

(22) Filed: Apr. 16, 2018

Related U.S. Application Data
(60) Provisional application No. 62/539,150, filed on Jul. 31, 2017.

(51) Int. Cl. G06T 1/20

(52) U.S. Cl. CPC G06T 1/20

(57) ABSTRACT

Aspects of this disclosure relate to a device for generating image content that includes a memory and processing circuitry coupled to the memory. The processing circuitry is configured to determine a dithered fractional VRS value for a core block based on a dithering factor for the core block and a fractional VRS value for the core block and determine a dithered fractional shading rate based on the dithered fractional VRS value. The processing circuitry is further configured to render the image based on the dithered fractional shading rate.

This application claims the benefit of U.S. Provisional Application No. 62/539,150, filed Jul. 31, 2017, the entire contents of which are hereby incorporated by reference.

### TECHNICAL FIELD

This disclosure relates to graphics processing.

### BACKGROUND

Computing devices often utilize a graphics processing unit (GPU) to accelerate the rendering of graphics data for display. Such computing devices may include, e.g., computer workstations, mobile phones such as so-called smartphones, embedded systems, personal computers, tablet computers, and video game consoles. GPUs typically execute a graphics processing pipeline that includes a plurality of processing stages which operate together to execute graphics processing commands. A host central processing unit (CPU) may control the operation of the GPU by issuing one or more graphics processing commands to the GPU. Modern day CPUs are typically capable of concurrently executing multiple applications, each of which may utilize the GPU during execution.

### SUMMARY

This disclosure is directed to applying variable rate shading (VRS) applied by a GPU during rendering. The amount of VRS that a GPU applies, has an effect on the amount of power the GPU consumes. In some examples, the GPU generates and applies a dithering factor to a fractional amount of VRS to generate a dithered VRS value. This disclosure describes using a dithering factor to adjust VRS values that are applied such that transitions between blocks (e.g., core blocks) that are rendered (e.g., shaded) at a different variable rate are less perceivable to a user.

In an example, a method for processing data includes determining, by one or more processors implemented in circuitry, a dithered fractional VRS value for a core block based on a dithering factor for the core block and a fractional VRS value for the core block, determining, by the one or more processors, a dithered fractional shading rate based on the dithered fractional VRS value, and rendering, by the one or more processors, the image based on the dithered fractional shading rate.

In some examples, a device for generating video content includes a memory and processing circuitry coupled to the memory. The processing circuitry is configured to determine a dithered fractional VRS value for a core block based on a dithering factor for the core block and a fractional VRS value for the core block, determine a dithered fractional shading rate based on the dithered fractional VRS value, and render the image based on the dithered fractional shading rate.

In some examples, a device for graphics processing includes means for determining a dithered fractional VRS value for a core block based on a dithering factor for the core block and a fractional VRS value for the core block, means for determining a dithered fractional shading rate based on the dithered fractional VRS value, and means for rendering the image based on the dithered fractional shading rate.

In some examples, this disclosure describes a non-transitory computer-readable storage medium storing instructions that, when executed, causes a processor to determine a dithered fractional VRS value for a core block based on a dithering factor for the core block and a fractional VRS value for the core block, determine a dithered fractional shading rate based on the dithered fractional VRS value, and render the image based on the dithered fractional shading rate.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example computing device that may be used to implement one or more techniques of this disclosure.

FIG. 2 is a block diagram illustrating a CPU, a GPU, and a memory of the computing device of FIG. 1 in further detail.

FIG. 3 is a flowchart illustrating an example method of processing data in accordance with one or more techniques of this disclosure.

FIG. 4 is a conceptual diagram illustrating a VRS distribution request that represents a gradient with fractional precision per pixel.

FIG. 5 is a conceptual diagram illustrating a determined single fractional VRS value at core block size.

FIG. 6 is a conceptual diagram illustrating a rounded VRS fractional to a nearest actual for each core block.

FIG. 7 is a conceptual diagram illustrating an applied actual VRS across core block.

FIG. 8 is a first conceptual diagram illustrating a discrete separation of VRS areas per core block.

FIG. 9 is a second conceptual diagram illustrating a discrete separation of VRS areas per core block.

FIG. 10A is a conceptual diagram illustrating a first example use of a dither formula to determine actual VRS based on fractional VRS per core block in accordance with one or more techniques of this disclosure.

FIG. 10B is a conceptual diagram illustrating a second example use of a dither formula to determine actual VRS based on fractional VRS per core block in accordance with one or more techniques of this disclosure.

FIG. 11A is a conceptual diagram illustrating an applied actual VRS across core block for the first example use of FIG. 10A in accordance with one or more techniques of this disclosure.

FIG. 11B is a conceptual diagram illustrating an applied actual VRS across core block for the second example use of FIG. 10B in accordance with one or more techniques of this disclosure.

FIG. 12 is a first conceptual diagram illustrating a dithered pattern of VRS choices per core block in accordance with one or more techniques of this disclosure.

FIG. 13 is a second conceptual diagram illustrating a dithered pattern of VRS choices per core block in accordance with one or more techniques of this disclosure.

FIG. 14 is a flowchart illustrating a further example method of processing data in accordance with one or more techniques of this disclosure.

### DETAILED DESCRIPTION

Graphics processing units (GPUs) are designed with various techniques to reduce power consumption. For example, a GPU may be configured to apply variable rate shading (VRS), which may reduce the amount of shader sampling power the GPU expends in rendering parts of an image. Variable rate shading may be used to accomplish foveated rendering, a technique for varying an amount of detail in an image according to one or more fixation points. For example, when applying VRS, a GPU may use a relatively high amount of detail (e.g., a relatively high resolution) for rendering a portion of an image surrounding a fixation point that the user is likely to directly view (e.g., a center portion of an image or fovea) and a relatively low amount of detail (e.g., a relatively low resolution) for rendering other portions of the image where a user is less likely to directly view (e.g., edge portions of the image). However, VRS may introduce visible discontinuities between different regions that were shaded at a different rate, which may be a significant visible artifact, particularly in a virtual reality (VR) setting or augmented reality (AR) setting.

Exemplary applications may include, but are not limited to, GPU hardware (HW) accelerated VRS, which may be used to accomplish foveated rendering, in VR and/or AR rendering systems. However, a limitation of VRS is that VRS may, in some systems, only be applied to a discrete number of pixels in horizontal and vertical directions. Furthermore, in some systems VRS may be limited to multiples of 2 pixels in horizontal and vertical directions. In some examples, VRS may be limited to the specific shading rates of 1, 1/2, 1/4, 1/8, etc. The limitations of such shading rates have several potential impacts. For example, such limitations may not allow an application to shade at any chosen fractional shading rate. Additionally, such limitations may also introduce a quantifiable discontinuity between different shading rate regions. As used herein, shading rate regions may refer to different regions that were shaded at a different rate. Introducing a quantifiable discontinuity may be considered a significant visual artifact when VRS is applied as part of foveated rendering for VR/AR use cases. As such, the quantifiable discontinuity may limit the amount of VRS applied.

In example techniques described in this disclosure, to accommodate the ability of applying a fractional amount of VRS, a dithering factor is included at core block sizes (e.g., 2×2, 2×4, 4×2, 4×4, 4×8, 8×4, 8×8, or another block size). Core blocks may refer to a grouping of pixels for processing a render target. As used herein, a dithering factor may refer to a randomized quantity to be used to randomize the variable shading rate. The core blocks themselves may still be shaded at a predefined fractional shading rate (e.g., 1, 1/2, 1/4 or 1/8). However, each core block relative to neighboring core blocks may be shaded at a different rate. This may create an overall dither distribution of the shading rate. The dithering factor may be taken from the fractional portion of the variable shading rate. At the macro level, the overall dither distribution of the shading rate may visually be imperceptible from applying any fractional shading rate changes across a rendered surface. As such, stronger VRS parameters may be applied compared to non-dithered VRS, which may lead to performance and power savings for a VR/AR system.

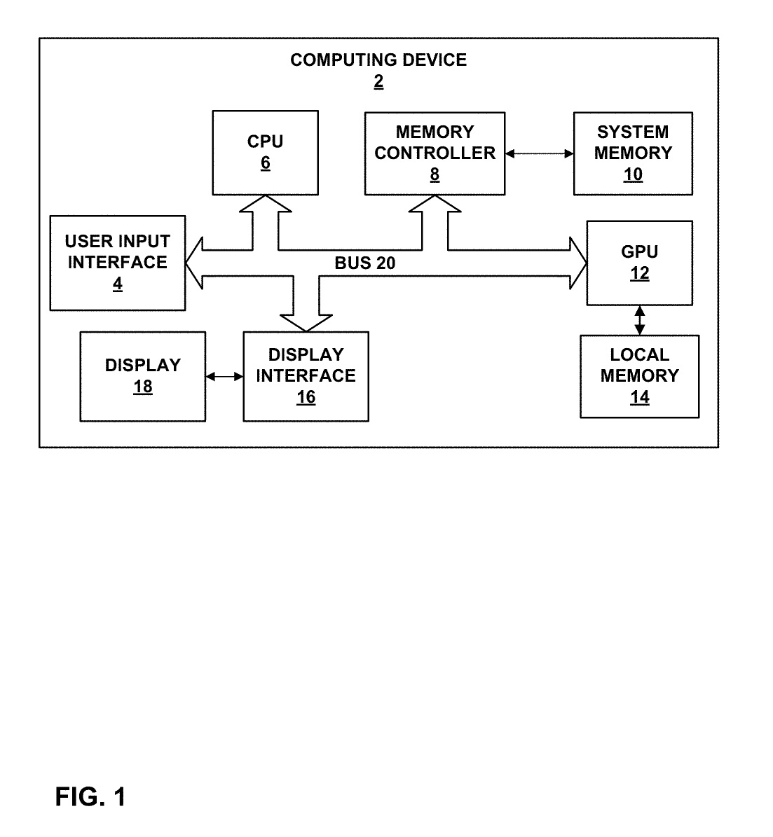

FIG. 1 is a block diagram illustrating an example computing device 2 that may be used to implement techniques of this disclosure. Computing device 2 may comprise a personal computer, a desktop computer, a laptop computer, a computer workstation, a video game platform or console, a wireless communication device (such as, e.g., a mobile telephone, a cellular telephone, a satellite telephone, and/or a mobile telephone handset), a landline telephone, an Internet telephone, a handheld device such as a portable video game device or a personal digital assistant (PDA), a personal music player, a video player, a display device, a television, a television set-top box, a server, an intermediate network device, a mainframe computer or any other type of device that processes and/or displays graphical data.

As illustrated in the example of FIG. 1, computing device 2 includes a user input interface 4, a CPU 6, a memory controller 8, a system memory 10, a GPU 12, a local memory 14 of GPU 12, a display interface 16, a display 18 and bus 20. User input interface 4, CPU 6, memory controller 8, GPU 12, and display interface 16 may communicate with each other using bus 20. Bus 20 may be any of a variety of bus structures, such as a third-generation bus (e.g., a HyperTransport bus or an InfiniBand bus), a second-generation bus (e.g., an Advanced Graphics Port bus, a Peripheral Component Interconnect (PCI) Express bus, or an Advanced eXtensible Interface (AXI) bus) or another type of bus or device interconnect. It should be noted that the specific configuration of buses and communication interfaces between the different components shown in FIG. 1 is merely exemplary, and other configurations of computing devices and/or other graphics processing systems with the same or different components may be used to implement the techniques of this disclosure.

CPU 6 may comprise a general-purpose or a special-purpose processor that controls operation of computing device 2. A user may provide input to computing device 2 to cause CPU 6 to execute one or more software applications. The software applications that execute on CPU 6 may include, for example, an operating system, a word processor application, an email application, a spread sheet application, a media player application, a video game application, a graphical user interface application or another program. The user may provide input to computing device 2 via one or more input devices (not shown) such as a keyboard, a mouse, a microphone, a touch pad or another input device that is coupled to computing device 2 via user input interface 4.

The software applications that execute on CPU 6 may include one or more graphics rendering instructions that instruct CPU 6 to cause the rendering of graphics data to display 18. In some examples, the software instructions may conform to a graphics application programming interface (API), such as, e.g., an Open Graphics Library (OpenGL®) API, an Open Graphics Library Embedded Systems (OpenGL ES) API, a Direct3D API, an X3D API, a RenderMan API, a WebGL API, or any other public or proprietary standard graphics API. In order to process the graphics rendering instructions, CPU 6 may issue one or more graphics rendering commands to GPU 12 to cause GPU 12 to perform some or all of the rendering of the graphics data. In some examples, the graphics data to be rendered may include a list of graphics primitives, e.g., points, lines, triangles, quadralaterals, triangle strips, etc.

Memory controller 8 facilitates the transfer of data going into and out of system memory 10. For example, memory controller 8 may receive memory read and write commands, and service such commands with respect to memory 10 in order to provide memory services for the components in computing device 2. Memory controller 8 is communicatively coupled to system memory 10. Although memory controller 8 is illustrated in the example computing device 2 of FIG. 1 as being a processing module that is separate from both CPU 6 and system memory 10, in other examples, some or all of the functionality of memory controller 8 may be implemented on one or both of CPU 6 and system memory 10.

System memory 10 may store program modules and/or instructions that are accessible for execution by CPU 6 and/or data for use by the programs executing on CPU 6. For example, system memory 10 may store user applications and graphics data associated with the applications. System memory 10 may additionally store information for use by and/or generated by other components of computing device 2. For example, system memory 10 may act as a device memory for GPU 12 and may store data to be operated on by GPU 12 as well as data resulting from operations performed by GPU 12. For example, system memory 10 may store any combination of texture buffers, depth buffers, stencil buffers, vertex buffers, frame buffers, or the like. In addition, system memory 10 may store command streams for processing by GPU 12. System memory 10 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), flash memory, a magnetic data media or an optical storage media.

GPU 12 may be configured to perform graphics operations to render one or more graphics primitives to display 18. Thus, when one of the software applications executing on CPU 6 uses graphics processing, CPU 6 may provide graphics commands and graphics data to GPU 12 for rendering to display 18. The graphics commands may include, e.g., drawing commands such as a draw call, GPU state programming commands, memory transfer commands, general-purpose computing commands, kernel execution commands, etc. In some examples, CPU 6 may provide the commands and graphics data to GPU 12 by writing the commands and graphics data to memory 10, which may be accessed by GPU 12. In some examples, GPU 12 may be further configured to perform general-purpose computing for applications executing on CPU 6.

GPU 12 may, in some instances, be built with a highly-parallel structure that provides more efficient processing of vector operations than CPU 6. For example, GPU 12 may include a plurality of processing elements that are configured to operate on multiple vertices or pixels in a parallel manner. The highly parallel nature of GPU 12 may, in some instances, allow GPU 12 to draw graphics images (e.g., GUIs and two-dimensional (2D) and/or three-dimensional (3D) graphics scenes) onto display 18 more quickly than drawing the scenes directly to display 18 using CPU 6. In addition, the highly parallel nature of GPU 12 may allow GPU 12 to process certain types of vector and matrix operations for general-purpose computing applications more quickly than CPU 6.

GPU 12 may, in some instances, be integrated into a motherboard of computing device 2. In other instances, GPU 12 may be present on a graphics card that is installed in a port in the motherboard of computing device 2 or may be otherwise incorporated within a peripheral device configured to interoperate with computing device 2. In further instances, GPU 12 may be located on the same microchip as CPU 6, forming a system on a chip (SoC). GPU 12 may include one or more processors, such as one or more microprocessors, application specific integrated circuits (ASICs), field programmable gate arrays (FPGAs), digital signal processors (DSPs), or other equivalent integrated circuits or discrete logic circuits.

GPU 12 may be directly coupled to GPU local memory 14. Thus, GPU 12 may read data from and write data to GPU local memory 14 without necessarily using bus 20. In other words, GPU 12 may process data locally using a local storage, instead of off-chip memory. This allows GPU 12 to operate in a more efficient manner by eliminating the need of GPU 12 to read and write data via bus 20, which may experience heavy bus traffic. In some instances, however, GPU 12 may not include a separate cache, but instead utilize system memory 10 via bus 20. GPU local memory 14 may include one or more volatile or non-volatile memories or storage devices, such as, e.g., random access memory (RAM), static RAM (SRAM), dynamic RAM (DRAM), erasable programmable ROM (EPROM), electrically erasable programmable ROM (EEPROM), flash memory, a magnetic data media or an optical storage media.

CPU 6 and/or GPU 12 may store rendered image data in a frame buffer that is allocated within system memory 10. Display interface 16 may retrieve the data from the frame buffer and configure display 18 to display the image represented by the rendered image data. In some examples, display interface 16 may include a digital-to-analog converter (DAC) that is configured to convert the digital values retrieved from the frame buffer into an analog signal consumable by display 18. In other examples, display interface 16 may pass the digital values directly to display 18 for processing. Display 18 may include a monitor, a television, a projection device, a liquid crystal display (LCD), a plasma display panel, a light emitting diode (LED) array, a cathode ray tube (CRT) display, electronic paper, a surface-conduction electron-emitted display (SED), a laser television display, a nanocrystal display or another type of display unit. Display 18 may be integrated within computing device 2. For instance, display 18 may be a screen of a mobile telephone handset or a tablet computer. Alternatively, display 18 may be a stand-alone device coupled to computing device 2 via a wired or wireless communications link. For instance, display 18 may be a computer monitor or flat panel display connected to a personal computer via a cable or wireless link.

In some examples, GPU 12 may generate graphics data for VR applications. For example, CPU 6 executes an application that commands and data for VR content and GPU 12 receives the commands and data and generates the graphics VR content for display. A user of device 2 may connect device 2 to headgear that the user wears. Display 18 may face the user's eyes. VR content may be particularly popular for gaming applications, but the techniques described in this disclosure are not limited to VR applications or gaming applications.

Computing device 2 may be configured to reduce power consumption through use of VRS. For example, GPU 12 may render certain portions of an image at a relatively high resolution and other portions of the image at a relatively low resolution, as compared to other rendering where all portions of the image are rendered at a same resolution. In some examples, GPU 12 may render certain portions of the image with a relatively low shading rate and other portions of the image at a relatively high shading rate, as compared to normal rendering where all portions of the image are rendered at the same shading rate. By using VRS, GPU 12 may render fewer fragments (e.g., image pixels) in areas that the user will not notice. For instance, from eye tracking or based on information from the executing application, GPU 12 may render portions where the user is actually looking, or portions where the user should be looking, with a higher resolution relative to the other portions.

Rendering graphics content at higher resolution tends to result in higher power consumption and heating of GPU 12 relative to rendering graphics content at lower resolution. However, rendering graphics content only at relatively low resolution results in poor user experience. Accordingly, by having image areas with different resolutions and/or shading rates, the viewer experience may be kept high because the areas with high resolution are areas where the viewer is or should be viewing, and areas where the viewer is not viewing or should not be viewing are at low resolution, thereby conserving power compared to systems that use only one resolution for an entire rendered image.

In some examples, areas of an image where the viewer is or should be viewing may be indicated by one or more fixation points. As used herein, a fixation point may refer to a portion of an image (e.g., a pixel or grouping of pixels) that a user is currently viewing or is likely to directly view. For example, GPU 12 and/or CPU 12 may determine the fixation point based on an eye position of a user. In this example, a fixation point may refer to a portion of an image being displayed that a user is currently viewing. For instance, computing device 2 may include one or more sensors configured to detect an eye position of a human user and to generate eye position data indicating the eye position of the user. In this example, computing device 2 may select, using the eye position data, a fixation point as one or more pixels that a user is currently viewing.

In some examples, a fixation point may indicate a pixel or grouping of pixels that a user is likely to directly view. For example, GPU 12 may receive an indication of a fixation point that a human user should be viewing. For instance, a director of a video may specify one or more fixation points that a user is likely to directly view. In some instances, computing device 2 or another computing device (e.g., a server) may determine one or more fixation points based on a detected eye position of other users. In this instance, computing device 2 or another computing device may specify the fixation point that is most viewed by other users.

As an example, if GPU 12 were to render VR content, with the entire image being rendered at the same baseline resolution, GPU 12 may consume approximately 1100 milli-watts. With VRS rendering, GPU 12 may consume approximately 300 milli-watts, representing approximately a 70% reduction in power.

In addition to power saving, GPU 12 may be able to improve fill rate because there are fewer pixels to render. As used herein, fill rate may refer to a number of frames that GPU 12 renders in for a given quantity of time. Faster fill rate allows for achieving the desired frame rate (e.g., enabling high quality VR rendering).

In some examples, the application executing on CPU 6 defines the foveation gain (e.g., where and how much foveation is applied) or the fractional VRS value (e.g., where and how much shading is applied). The foveation gain may define an amount of foveation (e.g., how low of a resolution to use) GPU 12 is to apply. For instance, increasing the amount of foveation may result in potentially more blurry content, and decreasing the amount of foveation may result in sharper image content. Similarly, the shading rate may define an amount of shading GPU 12 is to apply. For instance, decreasing the shading rate may result in potentially more blurry content, and increasing the shading rate may result in sharper image content. As previously noted, VRS may be used to accomplish foveated rendering.

However, in some systems, a shading rate may be applied to a discrete number of pixels in horizontal and vertical directions. For example, in some systems the shading rate may be limited to multiples of 2 pixels in horizontal and vertical directions, which may result in significant visual artifacts when applied as part of VRS rendering for VR/AR use cases.

In example techniques described in this disclosure, to accommodate the ability of applying a fractional amount of VRS, a dithering factor is included at core sample block sizes (e.g., 2×2, 4×2 or 2×4 pixels) to obscure or otherwise hide edges between portions of an image that are rendered using different amounts of VRS. The dither value may be applied at a granularity by which hardware evaluates the foveation factor and/or shading rate. For instance, the dither value may be applied to 8×4 blocks.

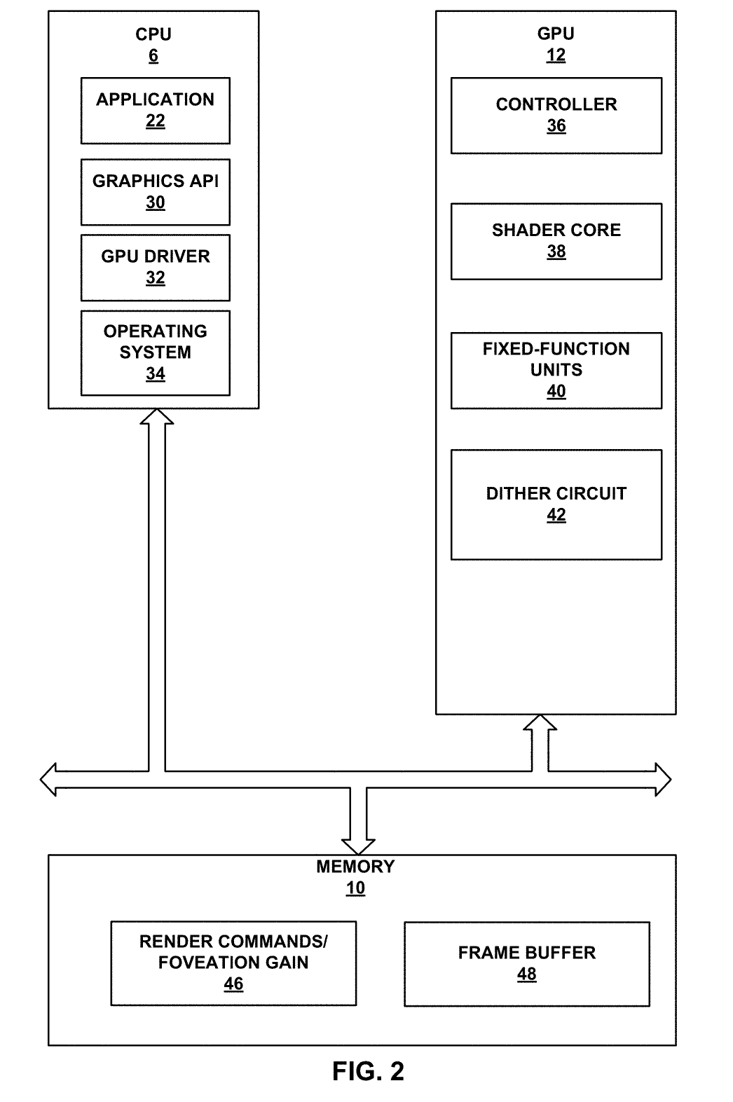

FIG. 2 is a block diagram illustrating CPU 6, GPU 12, and memory 10 of computing device 2 of FIG. 1 in further detail. As shown in FIG. 2, CPU 6 is communicatively coupled to GPU 12 and memory 10, and GPU 12 is communicatively coupled to CPU 6 and memory 10. GPU 12 may, in some examples, be integrated onto a motherboard with CPU 6. In additional examples, GPU 12 may be implemented on a graphics card that is installed in a port of a motherboard that includes CPU 6. In further examples, GPU 12 may be incorporated within a peripheral device that is configured to interoperate with CPU 6. In additional examples, GPU 12 may be located on the same microchip as CPU 6 forming a system on a chip (SoC). CPU 6 is configured to execute software application 22, a graphics API 30, a GPU driver 32, and an operating system 34.

GPU 12 includes a controller 36, shader core 38, one or more fixed-function units 40, and dither circuit 42. Although illustrated as separate components, in some examples, dither circuit 42 may be part of controller 36. In examples described in this disclosure, dither circuit 42 may determine various dithering and/or VRS factors of GPU 12.

Software application 22 may include at least some of one or more instructions that cause graphic content to be displayed or one or more instructions that cause a non-graphics task (e.g., a general-purpose computing task) to be performed on GPU 12. Software application 22 may issue instructions to graphics API 30. Graphics API 30 may be a runtime service that translates the instructions received from software application 22 into a format that is consumable by GPU driver 32. In some examples, graphics API 30 and GPU driver 32 may be part of the same software service.

GPU driver 32 receives the instructions from software application 22, via graphics API 30, and controls the operation of GPU 12 to service the instructions. For example, GPU driver 32 may formulate one or more command streams, place the command streams into memory 10, and instruct GPU 12 to execute command streams. GPU driver 32 may place the command streams into memory 10 and communicate with GPU 12 via operating system 34 (e.g., via one or more system calls).

Controller 36 is configured to retrieve the commands stored in the command streams and dispatch the commands for execution on shader core 38 and one or more fixed-function units 40. Controller 36 may dispatch commands from a command stream for execution on one or more fixed-function units 40 or a subset of shader core 38 and one or more fixed-function units 40. Controller 36 may be hardware of GPU 12, may be software or firmware executing on GPU 12, or a combination of both.

Shader core 38 includes programmable circuitry (e.g., processing cores on which software executes). One or more fixed-function units 40 include fixed function circuitry configured to perform limited operations with minimal functional flexibility. Shader core 38 and one or more fixed-function units 40 together form a graphics pipeline configured to perform graphics processing.

Shader core 38 may be configured to execute one or more shader programs that are downloaded onto GPU 12 from CPU 6. A shader program, in some examples, may be a compiled version of a program written in a high-level shading language (e.g., an OpenGL Shading Language (GLSL), a High-Level Shading Language (HLSL), a C for Graphics (Cg) shading language, etc.). In some examples, shader core 38 may include a plurality of processing units that are configured to operate in parallel (e.g., a SIMD pipeline). Shader core 38 may have a program memory that stores shader program instructions and an execution state register (e.g., a program counter register) that indicates the current instruction in the program memory being executed or the next instruction to be fetched. Examples of shader programs that execute on shader core 38 include, for example, vertex shaders, pixel shaders (also referred to as fragment shaders), geometry shaders, hull shaders, domain shaders, compute shaders, and/or unified shaders.

Fixed-function units 40 may include hardware that is hard-wired to perform certain functions. Although the fixed function hardware may be configurable, via one or more control signals, for example, to perform different functions, the fixed function hardware typically does not include a program memory that is capable of receiving user-compiled programs. In some examples, one or more fixed-function units 40 may include, for example, processing units that perform raster operations (e.g., depth testing, scissors testing, alpha blending, etc.).

GPU driver 32 of CPU 6 may be configured to write the command streams to memory 10, and controller 36 of GPU 12 may be configured to read the one or more commands of command streams from memory 10. In some examples, one or both of command streams may be stored as a ring buffer in memory 10. A ring buffer may be a buffer with a circular addressing scheme where CPU 6 and GPU 12 maintain synchronized state variables associated with the writing of data to and reading of data from the ring buffer. For example, if the first command stream is a ring buffer, each of CPU 6 and GPU 12 may store a write pointer indicating the next address to be written to in the ring buffer, and a read pointer indicating the next address to be read from in the ring buffer.

When CPU 6 writes a new command to the ring buffer, CPU 6 may update the write pointer in CPU 6 and instruct GPU 12 to update the write pointer in GPU 12. Similarly, when GPU 12 reads a new command from the ring buffer, GPU 12 may update the read pointer in GPU 12 and instruct CPU 6 to update the read pointer in CPU 6. Other synchronization mechanisms are possible. When the read and/or write pointers reach a highest address in the range of addresses allocated for the ring buffer, the read and/or write pointers may wrap around to the lowest address to implement a circular addressing scheme.

Example operation of an example GPU driver 32 and an example GPU controller 36 is now be described with respect to FIG. 2. GPU driver 32 receives one or more instructions from software application 22 that specify graphics operations and/or general-purpose computing operations to be performed by GPU 12. GPU driver 32 places the output command stream into memory 10, which is accessible by GPU controller 36. GPU driver 32 notifies GPU controller 36 that the command stream corresponding to software application 22 is available for processing. For example, GPU driver 32 may write to a GPU register (e.g., a GPU hardware register polled by GPU 12 and/or a GPU memory-mapped register polled by GPU 12) one or more values indicating that the command stream is ready for execution.

Upon notification that the command stream is ready for execution, controller 36 of GPU 12 may determine if resources are currently available on GPU 12 to begin executing the command stream. If resources are available, controller 36 begins to dispatch the commands in the command stream.

As part of graphics processing, CPU 6 may offload certain graphics processing tasks to GPU 12. For instance, software application 22 may generate attribute data for attributes of a plurality of vertices of primitives that interconnect to form a graphical object. Software application 22 may store the attribute data in a vertex buffer in memory 10. GPU 32 may instruct controller 36 to retrieve the attribute data for the attributes of the vertices for processing to generate graphics data for display.

In examples described in this disclosure, software application 22 generates foveation information that GPU driver 32 is to transmit to GPU 12. The foveation information defines an amount of foveation that GPU 12 is to apply (e.g., how much foveation and areas where the foveation is to applied). Foveation may refer rendering an image with one or more regions of relatively high quality image data (e.g., higher resolution, higher frame rate, etc.) and one or more other regions of relatively low quality image data (e.g., lower resolution, lower frame rate, etc.) . While examples described herein may use VRS to implement foveation, VRS may be used to implement other techniques. In some examples, software application 22 may generate a fractional VRS value defining a fractional VRS rate that GPU 12 is to apply (e.g., how much VRS and areas where the VRS is to be applied). For example, software application 22 may execute software application 22, which causes CPU 6 to generate the fractional VRS value. In some examples, GPU 12 receives the fractional VRS value. For example, the fractional VRS value may be received from another device or may be predetermined. Again, VRS may be used to accomplish foveated rendering.

As an example, software application 22 may define foveation information for each of the vertices as part of the attribute data stored in the vertex buffer. In this example, for vertices of primitives that are located in portions where the user is to be viewing, software application 22 may define those areas as having a relatively high resolution, and other portions where the user should not be viewing as having a relatively low resolution. There may be different resolution levels for different areas (e.g., a first portion has a high resolution, a second portion has medium resolution, and a third portion has low resolution). In this way, software application 22 may specify different resolutions for different portions of an image to implement foveation of the entire image.

As an example, software application 22 may define VRS information for each core block. In this example, for core blocks that are located in portions of the image where the user is to be viewing, software application 22 may define those areas as having a relatively high resolution, and other portions where the user should not be viewing as having a relatively low resolution. There may be resolutions for different areas (e.g., a first portion has a high resolution, a second portion has a medium resolution, and a third portion has a low resolution). In this way, software application 22 may specify different resolutions for different portions of an image based on VRS information.

Dither circuit 42 may generate a dithering factor. Generally, the dithering factor may be used to smoothly transition pixel values of core blocks. In some examples, the dithering factor may be a randomized value. Dither circuit 42 may generate dithering factor using a dithering algorithm. Examples of dithering algorithms may include, but are not limited to, the Floyd-Steinberg dithering algorithm, thresholding algorithms, random dithering algorithms, patterning dithering algorithms, ordered dithering algorithms (e.g., halftone dither matrix algorithm, Bayer matrix, etc.), error-diffusion dithering algorithms (e.g., the Floyd-Steinburg algorithm, minimized average error dithering algorithms, the Stucki dithering algorithm, the Burkes dithering algorithm, the Sierra dithering algorithm, the two-row dithering algorithm, filter lie algorithms, the Atkinson dithering algorithm, the gradient-based error-diffusion dithering algorithm) or other dithering algorithms.

Dither circuit 42 may determine a dithered fractional VRS value for a core block based on a dithering factor for the core block and a fractional VRS value for the core block. For instance, dither circuit 42 may add the dithering factor for a core block and the fractional VRS value for the core block to generate the dithered fractional VRS value for the core block. In some instances, dither circuit 42 may multiply the dithering factor for a core block and the fractional VRS value for the core block to generate the dithered fractional VRS value for the core block.

Dither circuit 42 may determine a dithered fractional shading rate. For example, dither circuit 42 may select, from a lookup table using the dithered fractional VRS value as an input to the lookup table, the dithered fractional shading rate. In some examples, the lookup table may specify predefined fractional shading rates that are multiples of 2. For example, the lookup table may specify predefined fractional shading rates that include 1, 1/2, 1/4, 1/8. For example, dither circuit 42 may select predefined fractional shading rate 1 when the dithered fractional VRS value is less than or equal to 1, 1/2 when the dithered fractional VRS value is greater than 1 and less than or equal to 2, 1/4 when the dithered fractional VRS value is greater than 2 and less than or equal to 3, and 1/8 when the dithered fractional VRS value is greater than 3.

Once dither circuit 42 determines the amount of VRS to apply, GPU driver 32 may store the information as render commands/foveation gain 46. Controller 36 may retrieve the VRS information from render commands/foveation gain 46, and cause GPU 12 to apply the appropriate dithered fractional shading rates. For instance, GPU 12 may render a first portion of an image using a first dithered fractional shading rate, a second portion of the image using a second dithered fractional shading rate, and so on.

GPU 12 may render an image based on the determined amount of VRS for each core block for rendering an image, where different core blocks may have different amounts of VRS. For example, the dithered fractional shading rate may indicate a number of pixels for rendering a core block. In this example, GPU 12 may render the number of pixels indicated by the dithered fractional shading rate. For instance, GPU 12 may render a first region of 2×2 core blocks with a first number of pixels (e.g., 4 pixels) when a dithered fractional shading rate indicates the first number of pixels for the first region, a second region of 2×2 core blocks with a second number of pixels (e.g., a 2 pixels) when a dithered fractional shading rate indicates the second number of pixels for the second region, and so on. The result is a rendered image that GPU 12 may store in frame buffer 48.

In some examples, the dithered fractional shading rate may indicate a size of VRS blocks for rendering a core block. In this example, the VRS block may represent a grouping of one or more pixels that GPU 12 may render for representing a respective core block of the image. For example, GPU 12 may generate the dithered fractional shading rate of 1 to indicate that a 8×4 core block is rendered using 1×1 VRS blocks in a first portion of an image. In this example, GPU 12 may generate the dithered fractional shading rate of 2 to indicate that a 8×4 core block is rendered using a 2×1 VRS block in a second portion of an image. In any case, GPU 12 may render the image by rendering each VRS block for the image.

There may be various ways in which GPU 12 performs foveation. As one example, the foveation gain information may indicate how much foveation to apply and to which portions of an image the foveation is to be applied. As one example, each vertex information may include the foveation gain. Controller 36 may determine which projection matrix a vertex shader executing on shader core 38 should multiply to the vertex coordinate data based on the foveation gain information. The projection matrix will define how much area the primitive formed by the vertex will encompass, and may set the resolution (e.g., number of pixels) within the primitive to be smaller than for other primitives on which a higher amount of resolution (e.g., less foveation) is used. When GPU 12 renders the primitive, the number of pixels in the primitive may be less than for other areas. Because the number of pixels in the primitive is less than for other areas, controller 36 may execute fewer instantiations of a fragment shader as compared to other areas. In some examples, controller 36 may cause shader core 38 and fixed-function units 40 to generate the entire image at the same “lower” resolution. Controller 36 may then cause shader core 38 and fixed-function units 40 to upsample with high quality filtering certain portions of the image.

It should be understood that the above provides various non-limiting examples. In general, dither circuit 42 may, for each core block of a plurality of core blocks of a region, determine a VRS to apply based on a dithering factor. GPU 12 may render an image based on the determined VRS.

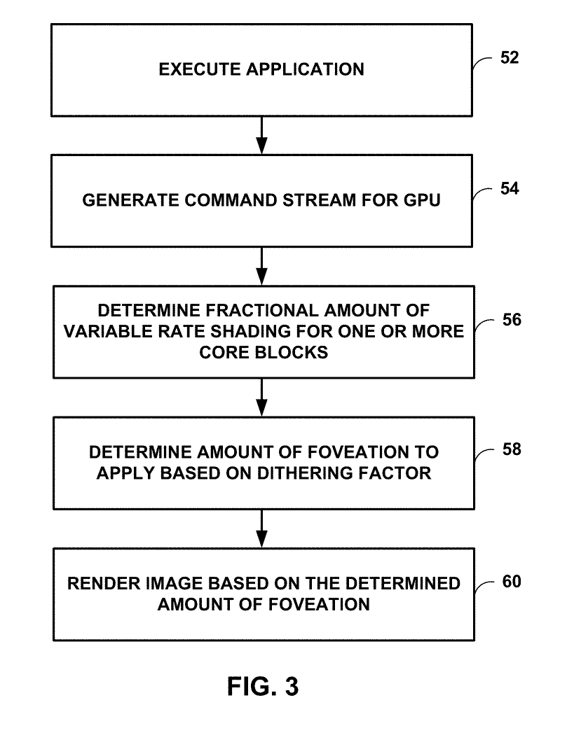

FIG. 3 is a flowchart illustrating an example method of processing data. This example may be applicable for rendering an image for a VR application. However, the techniques are not limited to rendering images for VR applications and are applicable generally to graphics processing.

As illustrated, software application 22 executes on CPU 6 (52), e.g., for generating VR content. The result of the execution is that software application 22 generates a command stream for GPU 12 (54). Dither circuit 42 may determine a fractional amount of VRS for one or more core blocks (56). For example, dither circuit 42 may receive a fractional VRS value from application 22. Dither circuit 42 may determine an amount of foveation to apply based on a dithering factor (58). For example, dither circuit 42 may multiply the fractional VRS value from application 22 by a respective dithering factor to generate a dithered fractional VRS value. GPU 32 may cause GPU 12 to render the image based on amount of foveation (60). For instance, GPU 32 may output information indicating where controller 36 is to retrieve render commands/foveation gain 46 from memory 10. GPU 12 may then render the image based on render commands/foveation gain 46.

GPU 12 may utilize various techniques such as selective multiplication of vertex information with different projection matrices or rendering an image at a low resolution and upsampling those portions were foveation gain is minimal. GPU 12 may apply foveation at certain portions as defined by software application 22 or in the center of the image, if software application 22 does not define the portions. By adjusting the amount of foveation GPU 12 is to apply, the example techniques may control the amount of power expended by GPU 12.

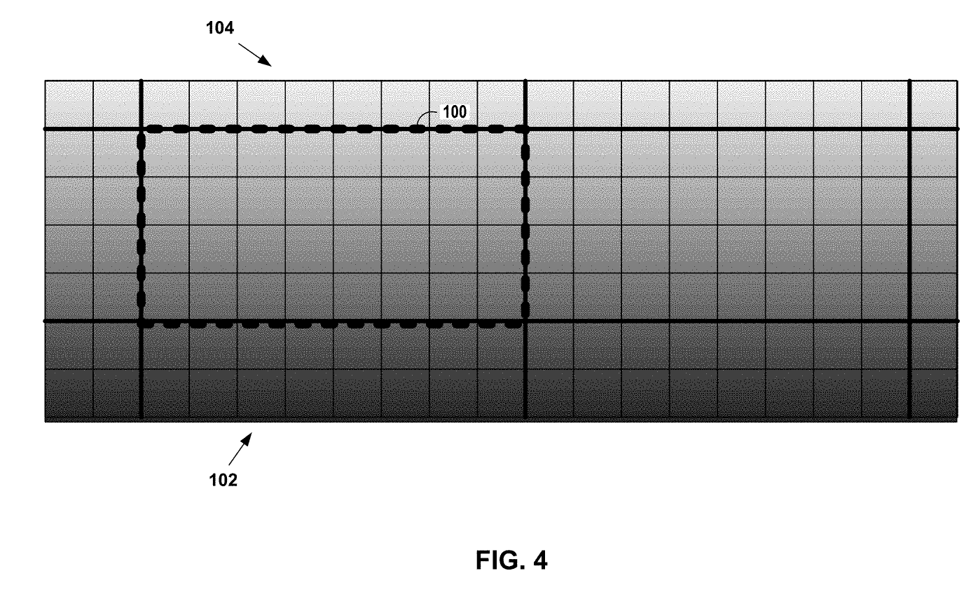

FIGS. 4-13, illustrate an exemplary zoomed in section (e.g., 19×7 pixels) of an overall render target to highlight what may occur at a core block size (e.g., 8×4) and VRS block size (e.g., 1×1, 2×1, 1×2, 2×2, 4×2, . . . , etc.). For shader core efficiency, one or more techniques may group multiple pixels together into a core block and assign this to an individual shader core.

FIG. 4 is a conceptual diagram illustrating a VRS distribution request that represents a gradient with fractional precision per pixel. For the example of FIG. 4, a VRS distribution request represents a gradient with fractional precision per pixel.

For example, CPU 6 executing software application 22 may output a set of VRS values corresponding to a darkness of the shading shown in FIG. 4. For instance, CPU 6 executing software application 22 may determine an amount of VRS for core block 100 based on bottom edge 102 of FIG. 4 being selected as fixation points that a user is likely to directly view. In this instance, CPU 6 executing software application 22 may output the set of VRS values that linearly extend from 0-5, where bottom edge 102 of FIG. 4 is zero and top edge 104 of FIG. 4 is 5.

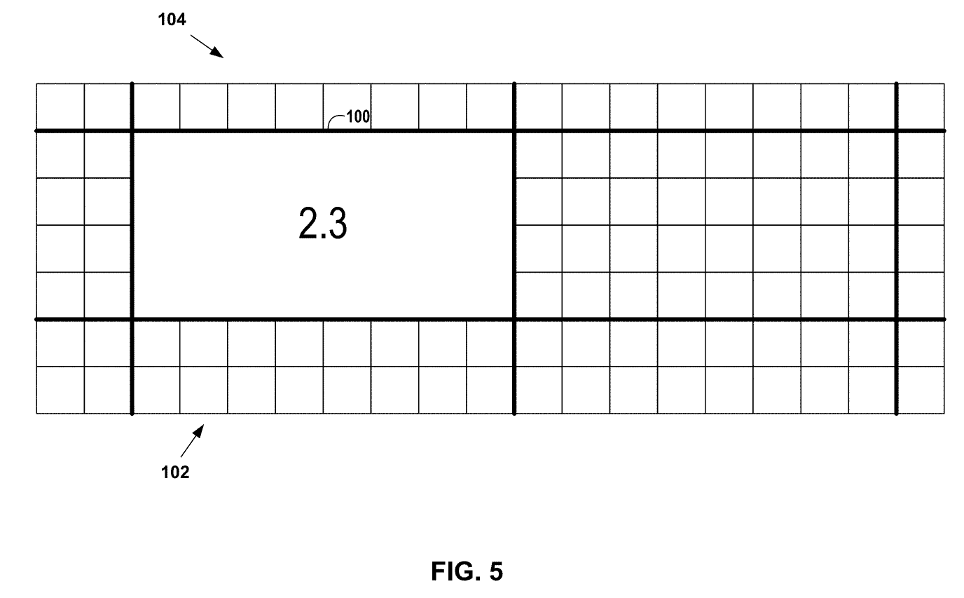

FIG. 5 is a conceptual diagram illustrating a determined single fractional VRS value at core block size. A VRS request may come from many concepts and may be fractional per pixel. However, an actual applied VRS may be a rectangular block of pixels (e.g., 1×, 2×1, 1×2, 2×2, 4×2, . . . , etc.) and may be the same across a core block. In the example of FIG. 5, CPU 6 selects a fractional VRS value of 2.3 for core block 100 based on the position of core block 100 from bottom edge 102 and top edge 104.

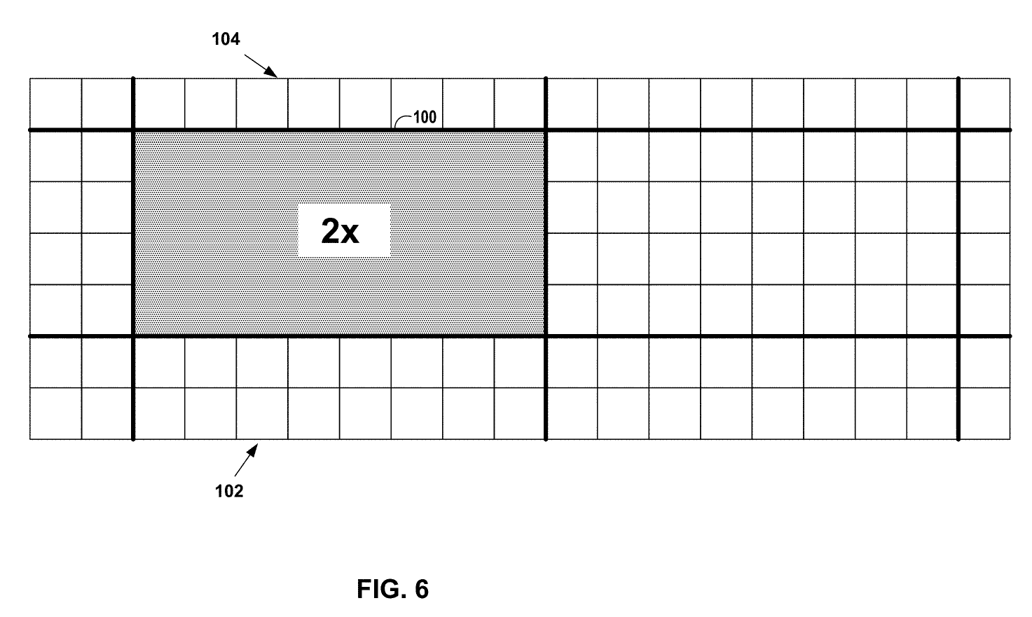

FIG. 6 is a conceptual diagram illustrating a rounded VRS fractional to a nearest actual for each core block. In the example of FIG. 6, a rounded VRS fractional value to a nearest actual for each core block may round 2.3 to 2×. That is, for example, GPU 12 may select one predefined fractional shading rate from a set of predefined fractional shading rates. In some examples, GPU 12 may apply a function (e.g., floor, ceiling, etc.) to identify an integer VRS fractional value. For instance, GPU 12 may apply a floor function to the VRS fractional value 2.3 to generate the integer value 2, which represents a 2×1 or a shading ratio of 1/2.

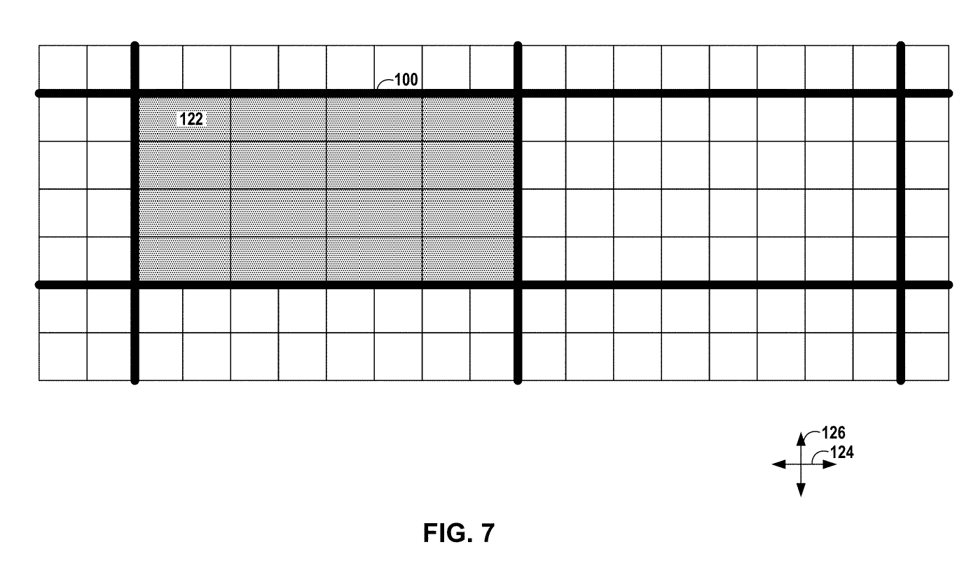

FIG. 7 is a conceptual diagram illustrating an applied actual VRS across core block. In the example of FIG. 7, GPU 12 may specify a 2×1 or 1/2 shading ratio. For example, dither circuit 42 specify unit 122 of core block 110 represents two pixels along horizontal direction 124 and one pixel along vertical direction 126. For instance, dither circuit 42 may specify a 2×1 VRS block to render core block 100.

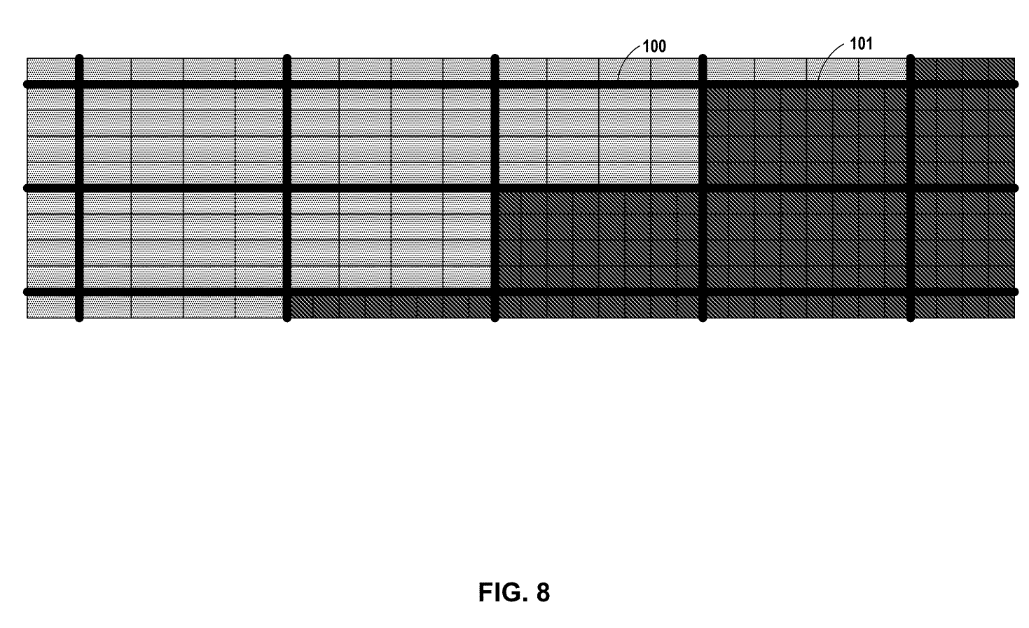

FIG. 8 is a first conceptual diagram illustrating a discrete separation of VRS areas per core block. Zooming out FIG. 7 would show a discrete separation of VRS areas per core block. As shown in FIG. 8, CPU 6 may specify a 2×1 or 1/2 shading ratio for core block 100 and a 1×1 or 1 shading ratio for core block 101. As shown, discontinuities between core block 100 and core block 101 may be apparent because of the change in shading from 2×1 in core block 100 to 1×1 in core block 101.

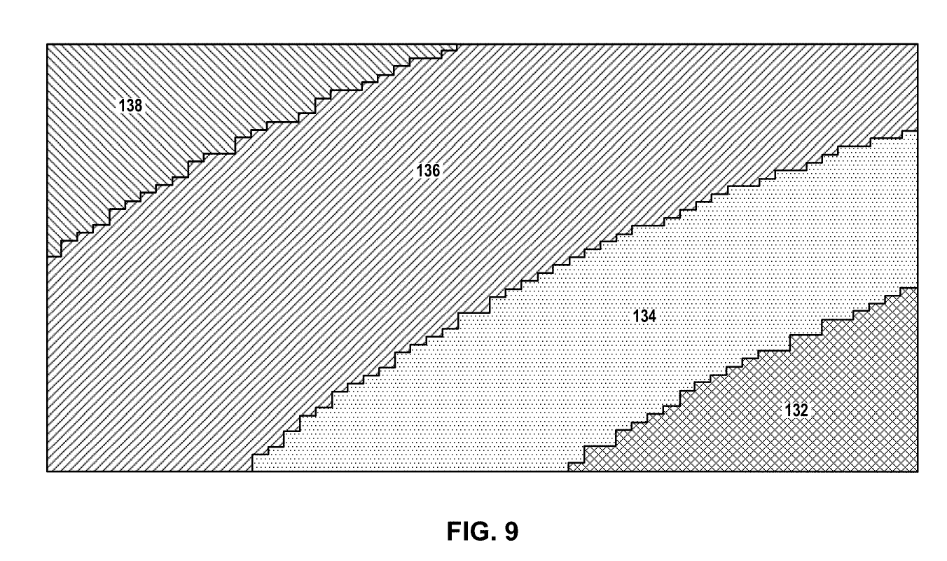

FIG. 9 is a second conceptual diagram illustrating a discrete separation of VRS areas per core block. FIG. 9 illustrates an example of VRS, where region 132 represents a very high resolution level (e.g., 1×1 or a shading ratio of 1), region 134 represents a high resolution level (e.g., 2×1 or a shading ratio of 1/2), region 136 represents a medium resolution level (e.g., 4×1 or a shading ratio of 1/4), and region 138 represents a low resolution level (e.g., 8×1 or a shading ratio of 1/8). In this example, a user focused on the lower right corner (e.g., a fixation point that the user is likely to directly view) may notice visual artifact between zones of transitions (e.g., boundaries between regions 132-138.

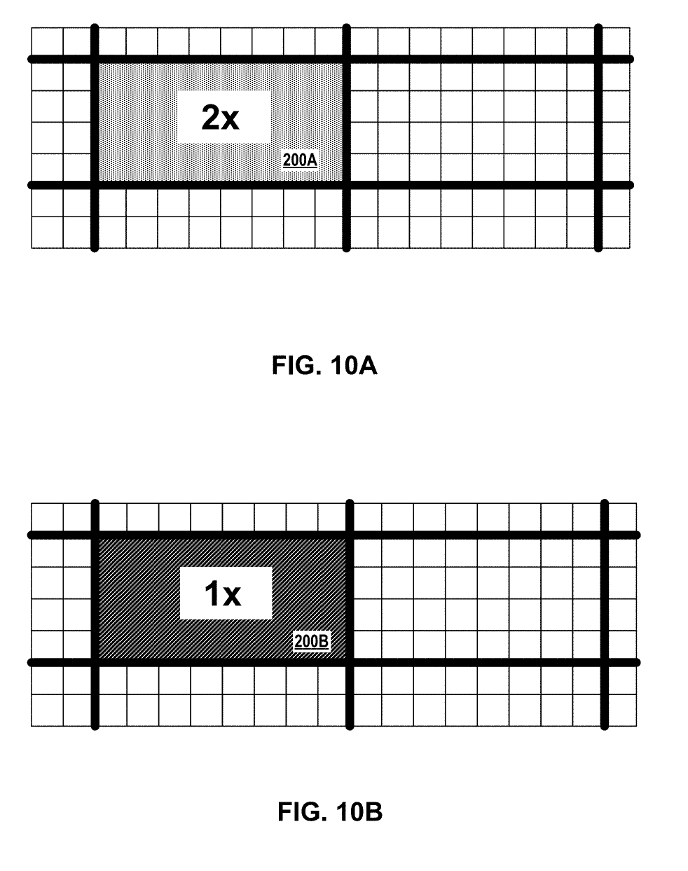

Use of dither formula to determine actual VRS based on fractional VRS per core block is discussed in the following. In the example of FIGS. 10A and 10B, GPU 12 may pick 2× or 1×.

To accommodate the ability of applying a fractional amount of VRS, GPU 12 may be configured to include a dithering factor at core sample block sizes. Core sample block sizes may include, but are not limited to, for example, 2×2 pixels, 2×4 pixels, 4×2 pixels, 4×4 pixels, 4×8 pixels, 8×4 pixels, 8×8 pixels, or another core sample block size. As used herein, a dithering factor may refer to a randomized quantity. Similar to non-dithered VRS, GPU 12 may shade the core blocks at a predefined fractional shading rate (e.g., 1, 1/2, 1/4 or 1/8). However, configuring GPU 12 to apply the dithering factor may help to shade each core block relative to neighboring core blocks at a different rate. Configuring GPU 12 to apply the dithering factor may help to create an overall dither distribution of the shading rate. GPU 12 may take the dithering factor from the fractional portion of the variable shading rate.

FIG. 10A is a conceptual diagram illustrating a first example use of a dither formula to determine actual VRS based on fractional VRS per core block. In the example of FIGS. 10A, dither circuit 42 picks 2×.

More specifically, for example, CPU 6 executing software application 22 may output a fractional VRS value for core block 200A of 1.5. In the example of FIG. 10A, dither circuit 42 randomly generates a dithering factor for core block 200A of 0.6. In this example, dither circuit 42 determines a dithered fractional VRS value of 2.1. In some examples, dither circuit 42 may select one predefined fractional shading rate from a set of predefined fractional shading rates. In some examples, dither circuit 42 may apply a function to the dithered fractional VRS value generate a dithered fractional shading rate. For instance, dither circuit 42 may apply a floor function to 2.1 to generate the integer value 2, which represents a 2×1 or a shading ratio of 1/2.

FIG. 10B is a conceptual diagram illustrating a first example use of a dither formula to determine actual VRS based on fractional VRS per core block. In the example of FIGS. 10B, dither circuit 42 picks 1×.

More specifically, for example, CPU 6 executing software application 22 may output a fractional VRS value for core block 200B of 1.5. That is, in the example of FIGS. 10A and 10B, core blocks 200A and 200B may have a same fractional VRS value. For instance, core blocks 200A and 200B may be positioned a same distance from a fixation point of an image.

In the example of FIG. 10A, dither circuit 42 randomly generates a dithering factor for core block 200B of 0.2. In this example, dither circuit 42 determines a dithered fractional VRS value of 1.7. In some examples, dither circuit 42 may select one predefined fractional shading rate from a set of predefined fractional shading rates. In some examples, dither circuit 42 may apply a function to the dithered fractional VRS value to generate a dithered fractional shading rate. For instance, dither circuit 42 may apply a floor function to 1.7 to generate the integer value 1, which represents a 1×1 or a shading ratio of 1.

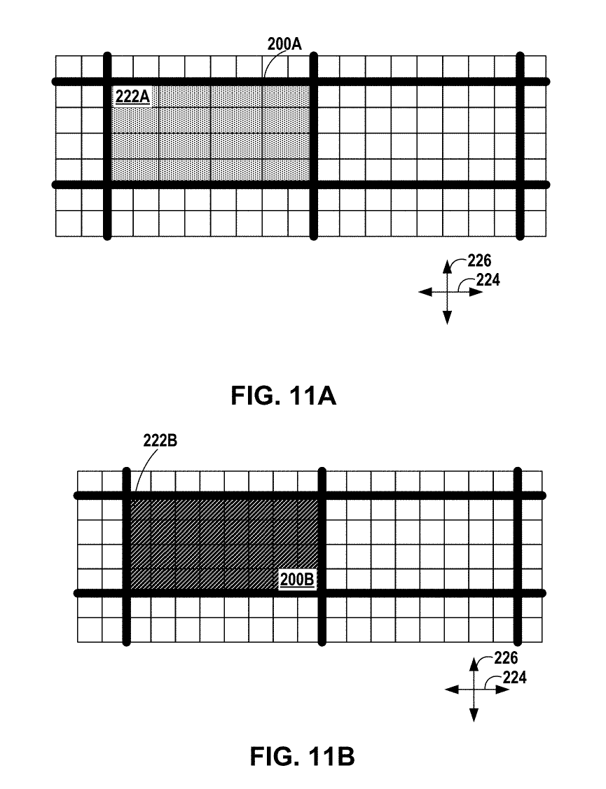

FIG. 11A is a conceptual diagram illustrating an applied actual VRS across core block 200A for the first example use of FIG. 10A. As shown in FIG. 11A, dither circuit 42 may specify a 2×1 or 1/2 shading ratio. For example, dither circuit 42 may specify unit 222A of core block 200A represents two pixels along horizontal direction 224 and one pixel along vertical direction 226. Said differently, for example, FIG. 11A illustrates a rendering of core block 200A based on a dithered fractional shading rate of 2, which may specify a 2×1 or 1/2 shading ratio. For instance, dither circuit 42 may specify a 2×1 VRS block to render core block 200A.

FIG. 11B is a conceptual diagram illustrating an applied actual VRS across core block for the second example use of FIG. 10B. As shown in FIG. 11B, dither circuit 42 may specify a 1×1 or 1/1 shading ratio. For example, dither circuit 42 may specify unit 222B of core block 200B represents one pixel along horizontal direction 224 and one pixel along vertical direction 226. Said differently, for example, FIG. 11B illustrates a rendering of core block 200B based on a dithered fractional shading rate of 1, which may specify a 1×1 or 1 shading ratio. For instance, dither circuit 42 may specify a 1×x1 VRS block to render core block 200B.

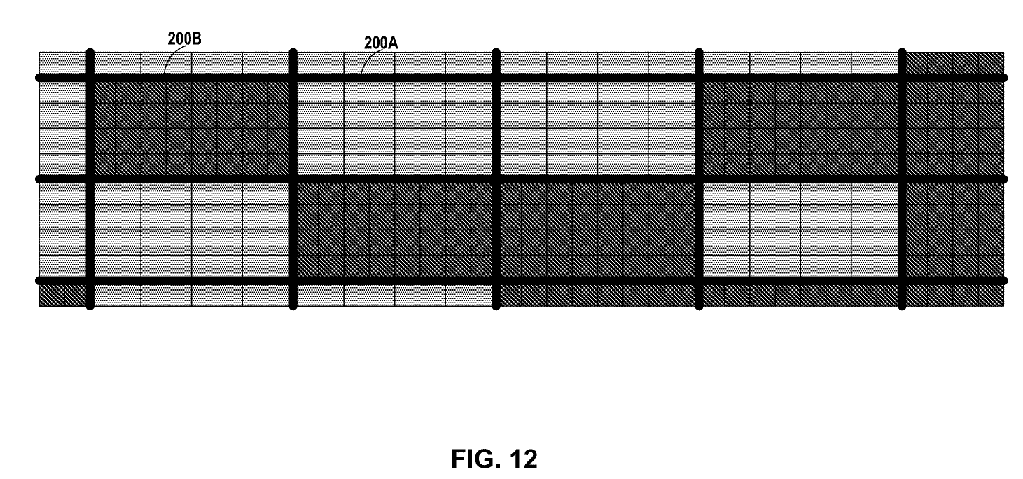

FIG. 12 is a first conceptual diagram illustrating a dithered pattern of VRS choices per core block. Zooming out the example of FIGS. 11A and 11B show an exemplary dithered pattern of VRS choices per core block. As shown in FIG. 12, dither circuit 42 may specify a 2×1 or 1/2 shading ratio for core block 200A and a 1×1 or 1 shading ratio for core block 200B. As shown, an edge between core block 200A and core block 101 may be apparent because of the change in shading from 2×1 in core block 200A to 1×1 in core block 101.

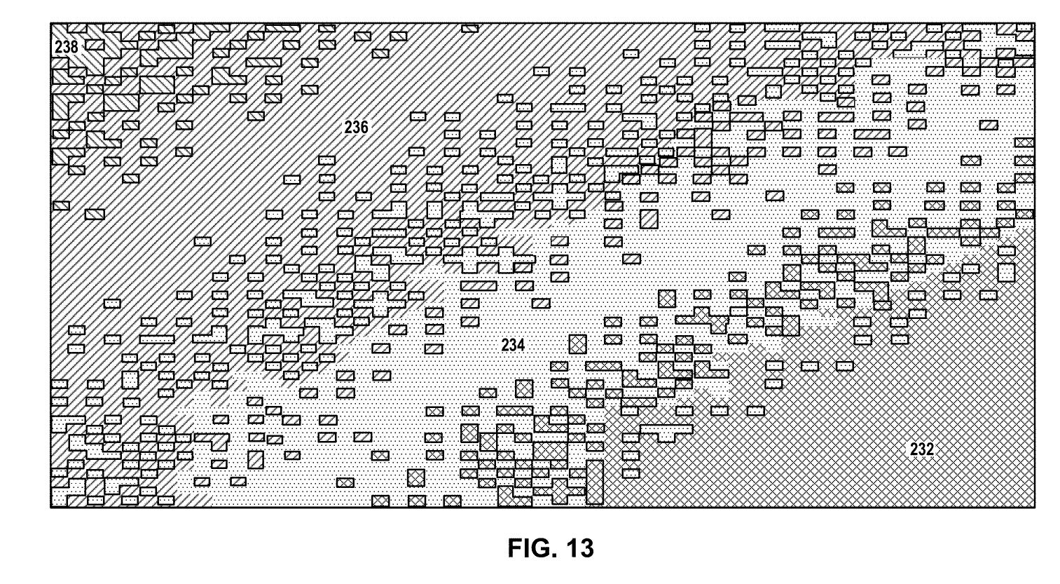

FIG. 13 is a second conceptual diagram illustrating dithered pattern of VRS choices per core block. FIG. 13 illustrates an example of VRS applied with a dithering factor, where region 232 represents a very high resolution level (e.g., 1×1 or a shading ratio of 1), region 234 represents a high resolution level (e.g., 2×1 or a shading ratio of 1/2), region 236 represents a medium resolution level (e.g., 4×1 or a shading ratio of 1/4), and region 238 represents a low resolution level (e.g., 8×1 or a shading ratio of 1/8).

At the macro level, the overall dither distribution of the shading rate for a dithered pattern of VRS may be visually imperceptible from applying any fractional shading rate changes across a rendered surface. For example, a user focused on the lower right corner (e.g., a fixation point that the user is likely to directly view) may not be able to perceive zones of transitions (e.g., boundaries between regions 232-238). As such, stronger VRS parameters may be applied compared to non-dithered VRS, which may lead to performance and power savings compared to systems that do not apply a dithering factor.

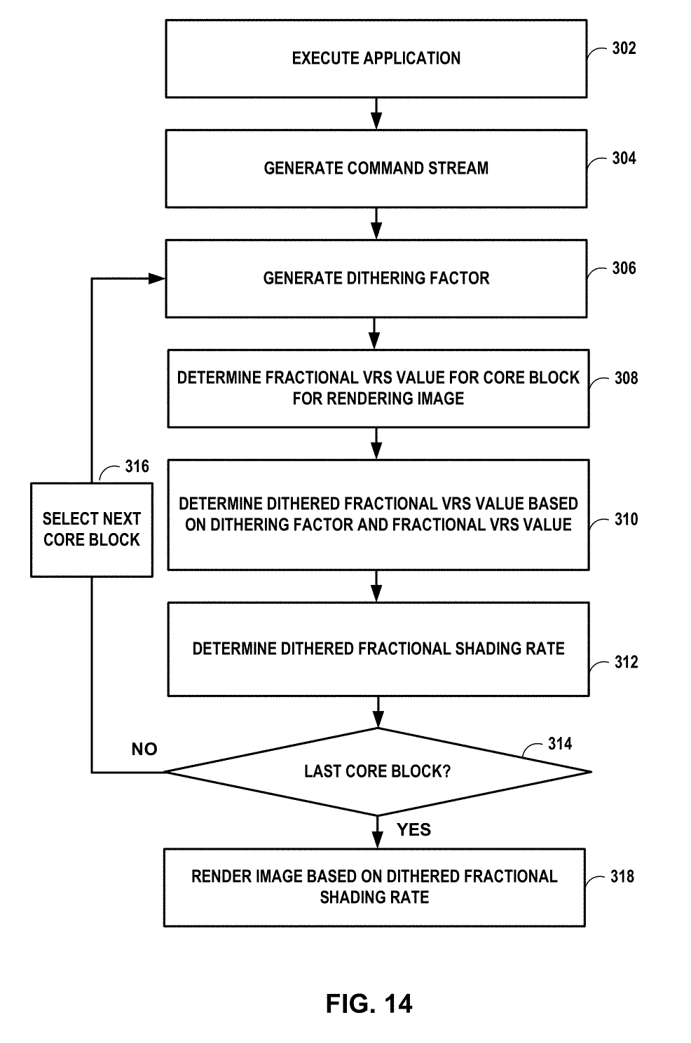

FIG. 14 is a flowchart illustrating a further example method of processing data. The example of FIG. 14 may be applicable for rendering an image for a VR application. However, the techniques are not limited to rendering images for VR applications and are applicable generally to graphics processing.

Software application 22 executes on CPU 6 (302), e.g., for generating VR content. The result of the execution is that software application 22 generates a command stream (304). Dither circuit 42 may generate a dither factor (306). Dither circuit 42 may determine a fractional VRS value for a core block for rendering an image (308). Dither circuit 42 may determine a dithered fractional VRS value based on the dithering factor and the fractional VRS value (310). For example, dither circuit 42 may determine the dithered fractional VRS value by adding the dithering factor to the fractional VRS value. In some examples, dither circuit 42 may determine the dithered fractional VRS value by multiplying the dithering factor with the fractional VRS value. Dither circuit 42 may determine a dithered fractional shading rate (312). For example, dither circuit 42 may apply a function to the dithered fractional VRS value to calculate the dithered fractional shading rate. In some examples, dither circuit 42 may select, from a lookup table using the dithered fractional VRS value as an input to the lookup table, the dithered fractional shading rate.

Dither circuit 42 may repeat steps 306-312 for each core block of the image. For example, in response to determining that a core block being processed is not a last core block for of the image (“NO” of step 314), dither circuit 42 may select a next core block (316) and go back to step 306 for the next core block.

For example, CPU 6 may determine a second dithered fractional VRS value for a second core block based on a second dithering factor for the second core block and a second fractional VRS value for the second core block. In this example, dither circuit 42 may determine a second dithered fractional shading rate for the second core block. For instance, dither circuit 42 may apply a function to the second dithered fractional VRS value to derive the second dithered fractional shading rate. In some instances, dither circuit 42 may select, from a lookup table using the second dithered fractional VRS value as an input to the lookup table, the second dithered fractional shading rate.

In response, however, to determining that a core block being processed is the last core block for of the image (“YES” of step 316), GPU driver 32 may cause GPU 12 to render the image based on the dithered fractional shading rate (318). For instance, GPU driver 32 may output information indicating where controller 36 is to retrieve render dithered fractional shading rate values from memory 10. GPU 12 may then render the image based on the dithered fractional shading rate values stored in memory 10.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry such as discrete hardware that performs processing.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be stored, embodied or encoded in a computer-readable medium, such as a computer-readable storage medium that stores instructions. Instructions embedded or encoded in a computer-readable medium may cause one or more processors to perform the techniques described herein, e.g., when the instructions are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable storage media that is tangible.

Various aspects and examples have been described. However, modifications can be made to the structure or techniques of this disclosure without departing from the scope of the following claims.

What is claimed is:

1. A method of processing image data, the method comprising:
determining, by one or more processors implemented in circuitry, a dithered fractional variable rate shading (VRS) value for a core block based on a dithering factor for the core block and a fractional VRS value for the core block;
determining, by the one or more processors, a dithered fractional shading rate based on the dithered fractional VRS value; and
rendering, by the one or more processors, an image based on the dithered fractional shading rate.

2. The method of claim 1, wherein determining the dithered fractional shading rate comprises applying a function to the dithered fractional VRS value to calculate the dithered fractional shading rate.

3. The method of claim 2, wherein applying the function to the dithered fractional VRS value comprises applying a floor function to the dithered fractional VRS value.

4. The method of claim 1, wherein determining the dithered fractional shading rate comprises selecting, from a lookup table using the dithered fractional VRS value as an input to the lookup table, the dithered fractional shading rate.

5. The method of claim 1, wherein the dithered fractional shading rate indicates a number of pixels for rendering the core block and wherein rendering the image comprises rendering the number of pixels indicated by the dithered fractional shading rate.

6. The method of claim 1, wherein the dithered fractional shading rate indicates a size of each VRS block of a plurality of VRS blocks for rendering the core block and wherein rendering the image comprises rendering the VRS block.

7. The method of claim 1, further comprising:
determining, by the one or more processors, the fractional VRS value based on an indication of a fixation point of the image.

8. The method of claim 7, wherein the fixation point of the image indicates a portion of the image that a user is likely to directly view.

9. The method of claim 7, further comprising:
determining, by the one or more processors, the fixation point based on an eye position of a user.

10. The method of claim 1, further comprising:
receiving, by the one or more processors, the fractional VRS value from an application executing at the one or more processors.

11. The method of claim 1, wherein determining the dithered fractional VRS value further comprises adding the dithering factor and the fractional VRS value.

12. The method of claim 1, wherein the core block comprises a size of 2×2 pixels, 2×4 pixels, 4×2 pixels, 4×4 pixels, 4×8 pixels, 8×4 pixels, or 8×8 pixels.

13. The method of claim 1, wherein the core block is a first core block, the dithered fractional VRS value is a first dithered fractional VRS value, the dithering factor is a first dithering factor, the fractional VRS value is a first fractional VRS value, and the dithered fractional shading rate is a first dithered fractional shading rate, the method further comprising:
determining, by the one or more processors, a second dithered fractional VRS value for a second core block based on a second dithering factor for the second core block and a second fractional VRS value for the second core block; and
determining, by the one or more processors, a second dithered fractional shading rate for the second core block based on the second dithered fractional VRS value for the second core block, wherein rendering the image is further based on the second dithered fractional shading rate for the second core block.

14. A device for generating image content, the device comprising:
a memory; and
processing circuitry coupled to the memory, the processing circuitry being configured to:
determine a dithered fractional variable rate shading (VRS) value for a core block based on a dithering factor for the core block and a fractional VRS value for the core block;
determine a dithered fractional shading rate based on the dithered fractional VRS value; and
render an image based on the dithered fractional shading rate.

15. The device of claim 14, wherein, to determine the dithered fractional shading rate, the processing circuitry is configured to apply a function to the dithered fractional VRS value to calculate the dithered fractional shading rate.

16. The device of claim 14, wherein, to apply the function to the dithered fractional VRS value, the processing circuitry is configured to apply a floor function to the dithered fractional VRS value.

17. The device of claim 14, wherein, to determine the dithered fractional shading rate, the processing circuitry is configured to select, from a lookup table using the dithered fractional VRS value as an input to the lookup table, the dithered fractional shading rate.

18. The device of claim 14, wherein the dithered fractional shading rate indicates a number of pixels for rendering the core block and wherein, to render the image, the processing circuitry is configured to render the number of pixels indicated by the dithered fractional shading rate.

19. The device of claim 14, wherein the dithered fractional shading rate indicates a size of each VRS block of a plurality of VRS blocks for rendering the core block and wherein, to render the image, the processing circuitry is configured to render the plurality of VRS blocks.

20. The device of claim 14, wherein the processing circuitry is configured to:
determine the fractional VRS value based on an indication of a fixation point of the image.

21. The device of claim 20, wherein the fixation point of the image indicates a portion of the image that a user is likely to directly view.

22. The device of claim 20, wherein the processing circuitry is configured to:
determine the fixation point based on an eye position of a user.

23. The device of claim 14, wherein the processing circuitry is configured to:
receive the fractional VRS value from an application executing at the processing circuitry.

24. The device of claim 14, wherein, to determine the dithered fractional VRS value, the processing circuitry is configured to add the dithering factor and the fractional VRS value.

25. The device of claim 14, wherein the core block is a first core block, the dithered fractional VRS value is a first dithered fractional VRS value, the dithering factor is a first dithering factor, the fractional VRS value is a first fractional VRS value, and the dithered fractional shading rate is a first dithered fractional shading rate, the processing circuitry being configured to:
determine a second dithered fractional VRS value for a second core block based on a second dithering factor for the second core block and a second fractional VRS value for the second core block; and
determine a second dithered fractional shading rate for the second core block based on the second dithered fractional VRS value for the second core block, wherein rendering the image is further based on the second dithered fractional shading rate for the second core block.

26. The device of claim 14, wherein the processing circuitry comprises a graphics processing unit (GPU).

27. The device of claim 14, wherein the device comprises one or more of a camera, a computer, a mobile device, a broadcast receiver device, or a set-top box.

28. The device of claim 14, wherein the device comprises at least one of:
an integrated circuit;
a microprocessor; or
a wireless communication device.

29. A device for graphics processing comprising:
means for determining a dithered fractional variable rate shading (VRS) value for a core block based on a dithering factor for the core block and a fractional VRS value for the core block;
means for determining a dithered fractional shading rate based on the dithered fractional VRS value; and
means for rendering an image based on the dithered fractional shading rate.

30. A non-transitory computer-readable storage medium storing instructions that, when executed, cause a processor to:
determine a dithered fractional variable rate shading (VRS) value for a core block based on a dithering factor for the core block and a fractional VRS value for the core block;
determine a dithered fractional shading rate based on the dithered fractional VRS value; and
render an image based on the dithered fractional shading rate.
